(19) United States
(12) Patent Application Publication
(10) Pub. No.: US 2012/0125966 A1
(43) Pub. Date: May 24, 2012

(54) STORAGE CONTAINER

(75) Inventor: Aaron Greenspon, Southfield, MI (US)

(73) Assignee: Milton Manufacturing, Inc., Detroit, MI (US)

(21) Appl. No.: 13/299,580

(22) Filed: Nov. 18, 2011

Related U.S. Application Data
(60) Provisional application No. 61/416,101, filed on Nov. 22, 2010.

(51) Int. Cl. A45C 3/00; A45C 13/06; B60R 11/00; A45C 13/30; A45C 13/36

(52) U.S. Cl. 224/572; 190/115; 190/124; 220/560.01; 190/121

(57) ABSTRACT

A storage container includes deflectable walls secured to each other and a bottom wall to form an interior. At least one of the walls defines an access cover at least partially detachable from adjacent walls to form an opening into the interior. Each of the walls includes an outer layer of a flexible ballistic material, and an inner layer of an insulation material. A first strap extends about a perimeter of the storage container including at least the access cover and the bottom wall. A second strap secures the storage container to a vehicle. The second strap connected to at least one of the walls. A flap is connected to one of the walls and is positioned over the access cover by rotation about an arc of rotation which is orthogonal to an arc of rotation of the access cover. The flap is secured using a third strap.

### CROSS-REFERENCE TO RELATED APPLICATION

This application claims the benefit of U.S. Provisional Application No. 61/416,101, filed on Nov. 22, 2010. The entire disclosure of the above application is incorporated herein by reference.

### FIELD

The present invention pertains to a storage container for use in a vehicle. More particularly, the present invention pertains to a storage container for use in a military vehicle which may be subjected to explosives.

### BACKGROUND

This section provides background information related to the present disclosure which is not necessarily prior art.

Military vehicles are designed with specific purposes in mind, for instance, strength, durability, reliability, adaptability, and so forth. They are utilitarian and designed with the purpose of accomplishing missions and keeping personnel safe. Because the design of these types of vehicles is so driven by function and safety, the conveniences found in civilian vehicles are often not provided, for instance, a location or container for safely stowing various personal items.

To that end, it is common for occupants of military vehicles to have personal items with them, such as sunglasses, water bottles, pens, or tools like screwdrivers or utility knives. In addition, due to the nature of military activities, it is possible that personnel within the vehicle may not be fully aware how long they will be away from the base. Thus, in some circumstances it may be desirable for the occupants to bring along additional supplies in anticipation of unexpectedly long trips.

In addition, vehicles which may be subjected to IED's, or improvised explosive devices, cannot use a typical storage container for personal items, supplies, etc. because of the hazards posed during an explosion around or beneath the vehicle. It is known that when an IED detonates in close proximity to a vehicle, the vehicle and all of its contents experience massive amounts of force from the explosion, including intense vibrational forces. These vibrational forces are capable of shattering rigid objects which can then ricochet within the vehicle and potentially cause substantial harm to the occupants. Therefore, military vehicles require specialized equipment even for storing typical items.

A storage container approved for use in a military vehicle:

(1) must not be capable of shattering or otherwise suffering damage during an explosion;

(2) must safely contain any of its contents which have shattered or exploded as a result of the IED within the container itself;

(3) must be secured firmly to the vehicle so that it does not move around during an explosion; and

(4) preferably, isolates and/or insulates its contents from the explosion to protect them from shattering or being otherwise damaged from vibrational forces.

Such a storage container does not currently exist for many military vehicles. In particular is the International MaxxPro MRAP (MaxxPro), which is a new armored military vehicle. The MaxxPro is available in several different models depending upon the specific intended use. The MaxxPro is intended to be mine-resistant. The MaxxPro provides significant advancements over previous or existing military vehicles (e.g., the HUMVEE) in terms of the payload it can carry and safety it provides to its occupants. However, the MaxxPro was not designed to include a storage container for any personal items belonging to the occupants.

Thus, there remains a need for a storage container which meets the military's criteria above to provide a storage container which is safe for use in a military vehicle.

The present invention, as is detailed hereinbelow, seeks to resolve these issues by providing a flexible lightweight storage container which cannot shatter or explode, which can safely contain any of its contents that have shattered or exploded, and which can be safely secured to the vehicle.

### SUMMARY

This section provides a general summary of the disclosure, and is not a comprehensive disclosure of its full scope or all of its features.

In an embodiment hereof, the present invention provides a storage container for use in a vehicle which generally comprises:

(a) a flexible enclosure including a plurality of walls secured to each other to form an interior, each of the walls including an outer layer formed from a flexible protective material, and an inner layer formed from an insulation material;

(b) at least one wall from the plurality of walls defining an access cover that is, at least, partially detachable from adjacent walls to form an opening, the access cover including means for detachably securing at least one portion of the access cover to the adjacent walls; and

(c) means for securing the storage container to the vehicle.

Optionally, the storage container can comprise a strap or other suitable means allowing the storage container to be removed from the vehicle and carried easily by hand.

The storage container can also optionally include a removable liner in the interior of the enclosure to aid with cleaning. The liner can also form a water-tight barrier within the interior which can have particular use, such as for filling the storage container with ice.

The storage container can further optionally include a flap that can be positioned over the access cover to aid with insulating the interior, as well as providing an additional protective layer over the access cover.

For a more complete understanding of the present invention, reference is made to the following detailed description and accompanying drawings. In the drawing, like reference characters refer to like parts throughout the views in which:

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a right front perspective view of an embodiment of a storage container of the present invention hereof showing an interior of the enclosure;

FIG. 2 is a right front perspective view showing the access cover opened;

FIG. 3 is a right side perspective view showing the access cover closed; and

FIG. 4 is a left side perspective view showing the access cover closed, the shoulder strap connected atop the enclosure, and straps connecting the storage container to a component of a vehicle.

Corresponding reference numerals indicate corresponding parts throughout the several views of the drawings.

### DETAILED DESCRIPTION

Example embodiments will now be described more fully with reference to the accompanying drawings.

At the outset it is to be noted that the storage container described hereinbelow has been designed purposefully for use in a military vehicle. However, the storage container may be suitable for use in any other type of vehicle, or even when it is intended to be carried only.

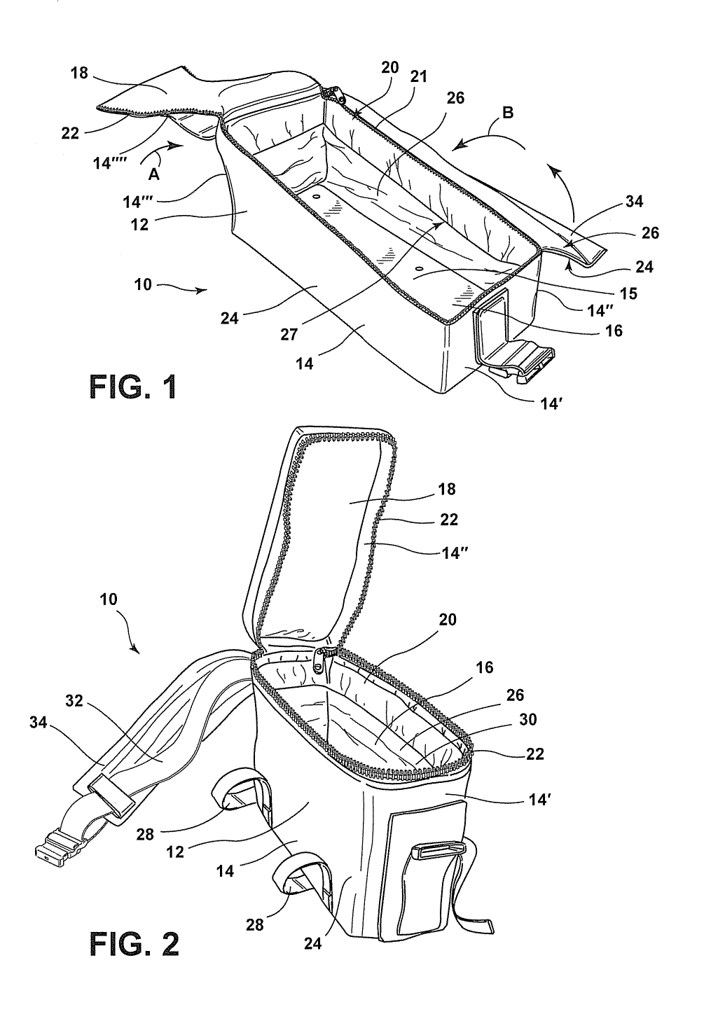

In accordance with the present invention and as shown generally in FIG. 1, there is provided a storage container 10 for use in a vehicle which generally comprises:

(a) a flexible enclosure 12 including a plurality of walls 14,14′,14″,14′″,14″″ secured to each other and a bottom wall 15 to form an interior 16, at least one of the walls 14″″ defining an access cover 18 that is at least partially detachable from the adjacent walls 14,14′,14″,14′″ to form an opening 20. The access cover 18 includes means 22 for detachably securing at least a portion of the access cover 18 to an adjacent wall 14,14′,14″,14′″;

(b) each of the walls 14,14′,14″,14′″,14″″ including an outer layer 24 formed from a flexible protective material, and an inner layer 26 formed from an insulation material; and

(c) means 28 for securing the storage container 10 to the vehicle.

The flexible enclosure 12 can comprise any suitable shape for use with any particular vehicle, including a box, a sphere, and so forth. It is also known that it may be desirable to customize the shape of the flexible enclosure 12 for particular placement within a particular vehicle. The flexible enclosure 12 includes the plurality of walls 14,14′,14″,14′″,14″″ which are secured to each other to form the interior 16.

At least one of the walls 14″″ from the plurality of walls 14,14′,14″,14′″,14″″ defines an access cover 18 to provide access to the interior 16 of the enclosure 12. The access cover 18 is at least partially detachable from the adjacent walls 14,14′,14″,14′″ to form an opening 20 in the enclosure 12. The access cover 18 is connected or joined to the adjacent walls 14,14′,14″,14′″ using a releasable fastener 21 such as a zipper and/or hook-and-loop fasteners, however, any other suitable fastener which is well known to one having ordinary skill in the art can be used herewith. The access cover 18 further includes means 22 for detachably securing at least one portion of the access cover 18 to the adjacent walls 14,14′,14″,14′″, including a first strap extending at least partially about a perimeter of the storage container 10 including at least the access cover 18 and at least one of the wall 14′, 14′″. Preferably, the means 22 for detachably securing should be capable of being quickly opened and closed, is strong, is approved for military use, and will not be damaged by intense vibrational forces. The means 22 for detachably securing are preferably secured to edges of the access cover 18 with the access cover positioned over the opening 20 so that the access cover 18 can be removably sealed over the opening 20 to safely contain the contents of the storage container 10. The means 22 for detachable securing is secured to the enclosure 12 via any suitable means which are well-known to one having ordinary skill in the art, including sewing/stitching, adhesives, fasteners, or the like.

Each of the walls 14,14′,14″,14′″,14″″ in the enclosure 12 includes an outer layer 24 formed from a flexible protective material capable of containing any items which may have shattered within the interior 16, such as broken glass or metal. Therefore, the outer layer 24 can be formed from a high-strength woven material, such as a para-aramid synthetic fiber. Preferably, the protective material is formed from a woven nylon which is commonly known by the name “ballistic nylon.”

Each of the walls 14,14′,14″,14′″,14″″ in the enclosure 12 also includes an inner layer 26 formed from an insulation material. The insulation material can comprise any suitable type of insulation material which is well-known to one having ordinary skill in the art, including polymeric fibers, fiberglass insulation, and so forth. The insulation material can include a backing material, such as a reflective sheet 27 to provide structure to the insulation and assist in providing insulation. The insulation material is provided to help insulate the contents stowed in the interior 16. For instance, the occupants of the vehicle may be out with the vehicle for an extended period of time during hot conditions, and therefore it may be desirable to store chilled water in the enclosure 12. The interior 16 of the enclosure 12 can also be filled with ice or liquid to help keep the contents at a cold temperature for an extended period of time.

Optionally, the enclosure 12 can include a plastic liner 30 which is preferably dimensioned to match the interior dimensions of the enclosure 12 for fitment therein. Preferably the liner 30 can be removable to aid with cleaning. Preferably the liner 30 is also water-tight to provide a leak-free barrier when ice is placed within the interior 16. The plastic liner 30 can be formed from any suitable pliable plastic material which is well-known to one having ordinary skill in the art, such as low-density polyethylene or the like. Preferably the plastic liner 30 has a thickness of about 20 mils.

The storage container 10 also includes means 28 for securing the storage container to the vehicle 40. As discussed above, it is essential that the storage container 10 be fixed in position and not capable of moving around within the vehicle 40 during an explosion. The means 28 for securing the storage container 10 in place can include at least one second strap or belt 29 and buckle 31, tie-downs, or any other suitable means which are well-known to one having ordinary skill in the art. Preferably the storage container 10 is placed in the vehicle 40 at a location which is considered relatively safe by one having ordinary skill in the art, such as a console 42 between seats.

Since the storage container 10 is intended for military use, it is desirable that the means for securing 28 comprises military-grade or military-issued materials, such as the buckle 31 and strap 29. The means 28 for securing the storage container 10 should allow the storage container 10 to be quickly and easily secured to or removed from the vehicle.

Optionally, the storage container 10 can also include means for carrying 32 to enable the storage container 10 to be carried by an occupant of the vehicle. The means for carrying 32 can include a third strap 36 such as an extendable shoulder strap and buckle 38, and/or handles.

It is to be understood that it may be desirable to remove the storage container 10 from the vehicle when the vehicle has reached its destination or the vehicle has stopped for an extended period of time. At that time, it may be desirable for an occupant of the vehicle to carry the storage container 10, and the means for carrying 32 assists the occupant in doing so.

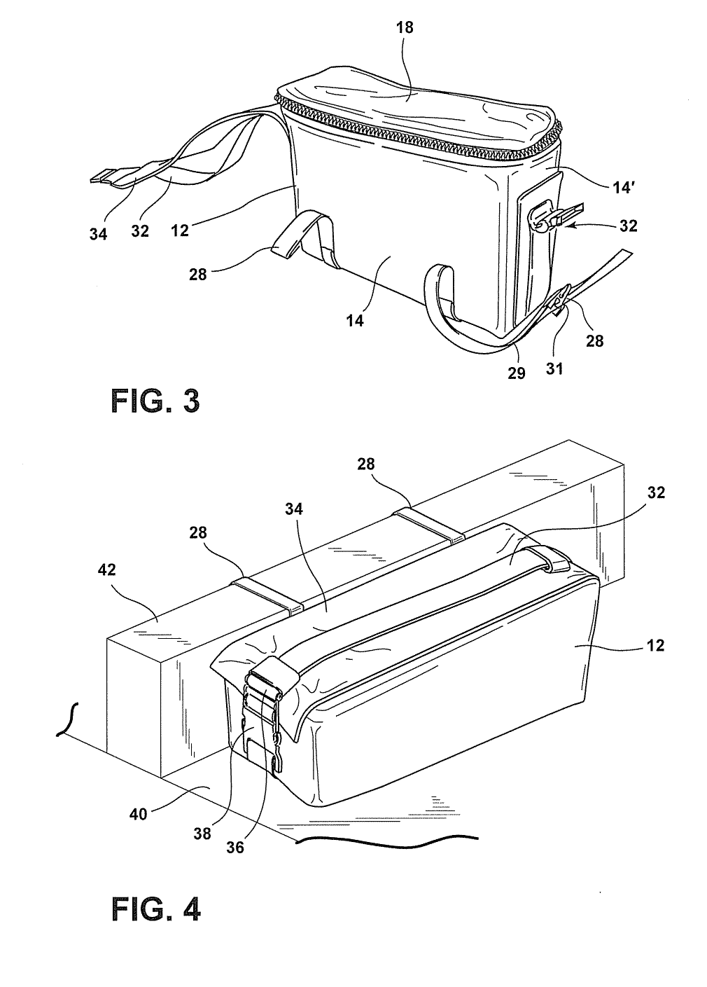

As shown in FIGS. 1-4 the storage container 10 can further include a flap 34 that can be positioned over the access cover 18 to aid with insulating the interior 16 or to provide an additional protective layer over the access cover 18. The flap 34 preferably includes the outer layer 24 and the inner layer 26, formed in the same manner as the walls 14,14′,14″,14′″,14″″ and the access cover 18. The flap 34 can be secured to the enclosure 12 by any means which are well-known to one having ordinary skill in the art. For example, the flap 34 can be pivotally attached by securing an edge of the enclosure 12 near the opening 20 so that the flap 34 can be rotated either over or away from the opening 20. Flap 34 can be positioned over the access cover 18 by rotation about an arc of rotation which is co-axial or parallel to an arc of rotation “A” of the access cover 18. Flap 34 can also be positioned over the access cover 18 by rotation about an arc of rotation “B” which is orthogonal to arc of rotation “A” of the access cover 18. The arc of rotation “B” of the flap being orthogonal to the arc of rotation “A” of the access cover 18 provides for maximum coverage of the means for detachably securing the access cover The flap 34 can also be secured over the opening such as by a zipper or other known and suitable fasteners.

As is apparent from the preceding, the present invention provides a flexible lightweight storage container which cannot shatter or explode, which can safely contain any of its contents that have shattered or exploded, and which can be safely secured to the vehicle.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A storage container, comprising:
a flexible enclosure having:
a plurality of walls secured to each other and a bottom wall to form an interior;
at least one of the walls defines an access cover that is at least partially detachable from adjacent ones of the walls to form an opening;
the access cover includes means for detachably securing the access cover to at least one of the walls;
each of the walls including an outer layer of a flexible ballistic material, and an inner layer of an insulation material; and
means for securing the storage container to a vehicle.

2. The storage container of claim 1, wherein the means for detachably securing comprises a strap extending about a perimeter of the storage container including at least the access cover and the bottom wall.

3. The storage container of claim 2, wherein the means for securing comprises at least one second strap fixedly connected to the bottom wall and releasably connected to the vehicle.

4. The storage container of claim 1, further including a plastic liner received in the interior having dimensions matching dimensions of the interior.

5. The storage container of claim 4, wherein the plastic liner is water-tight to provide a leak-free barrier.

6. The storage container of claim 1, further including an extendable container manual carrying strap connected to the flexible enclosure.

7. The storage container of claim 1, wherein the ballistic material comprises a para-aramid synthetic fiber.

8. The storage container of claim 1, wherein the insulation material further includes a reflective sheet.

9. The storage container of claim 1, wherein the means for securing includes a strap and a buckle.

10. The storage container of claim 1, further including a flap positioned over the access cover by rotation about an arc of rotation which is orthogonal to an arc of rotation of the access cover.

11. The storage container of claim 1, further including a flap positioned over the access cover by rotation about an arc of rotation which is parallel to an arc of rotation of the access cover.

12. A storage container, comprising:
a flexible enclosure having:
a plurality of walls secured to each other and a bottom wall to form an interior;
at least one of the walls defines an access cover that is at least partially detachable from adjacent ones of the walls to form an opening;
the access cover includes a releasable fastener and means for detachably securing the access cover to at least one of the walls, the means for detachably securing extending at least partially about a perimeter of the storage container including at least the access cover and at least one of the walls;
each of the walls including an outer layer of a flexible ballistic material, and an inner layer of an insulation material; and
means for securing the storage container to a vehicle; and
a water-tight plastic liner received in the interior.

13. The storage container of claim 12, wherein the plastic liner has dimensions matching dimensions of the interior.

14. The storage container of claim 12, wherein the means for detachably securing the access cover comprises a zipper.

15. The storage container of claim 12, further including a flap positioned over the access cover by rotation about an arc of rotation which is orthogonal to an arc of rotation of the access cover, the flap attached at an edge of the flap to the flexible enclosure allowing the flap to rotate toward and away from the opening, the arc of rotation of the flap being orthogonal to the arc of rotation of the access cover providing maximum cover of the means for detachably securing the access cover.

16. A storage container, comprising:
a plurality of deflectable walls secured to each other and a bottom wall to form an interior, wherein:
at least one of the walls defines an access cover that is at least partially detachable from adjacent ones of the walls to form an opening into the interior; and
each of the walls and the access cover include an outer layer of a flexible ballistic material, and an inner layer of an insulation material;
a first strap extending about a perimeter of the storage container including at least the access cover and the bottom wall;
a second strap acting to secure the storage container to a vehicle, the second strap connected to at least one of the walls; and
a flap connected to one of the walls and positioned over the access cover, the flap secured over and covering the access cover using a third strap.

17. The storage container of claim 16, wherein the ballistic material comprises a para-aramid synthetic fiber.

18. The storage container of claim 16, wherein the insulation material further includes a reflective sheet.

19. The storage container of claim 16, further including a water-tight plastic liner received in the interior having dimensions matching dimensions of the interior.

20. The storage container of claim 16, wherein the flap includes the outer layer of flexible ballistic material and the inner layer of insulation material, and is pivotally attached proximate to the opening for rotation to position the flap over the access cover.
